(19) United States
(12) Patent Application Publication
(10) Pub. No.: US 2014/0348491 A1
(43) Pub. Date: Nov. 27, 2014

(54) METHOD AND APPARATUS FOR ADVERTISEMENT PLAYOUT CONFIRMATION IN DIGITAL CINEMA

(71) Applicant: THOMPSON LICENSING, Issy de Moulineaux (FR)

(72) Inventor: William Gibbens Redmann, Glendale, CA (US)

(21) Appl. No.: 14/368,605

(22) PCT Filed: Aug. 31, 2012
(86) PCT No.: PCT/US12/53393

§ 371 Date: Jun. 25, 2014

Related U.S. Application Data
(60) Provisional application No. 61/592,674, filed on Jan. 31, 2012.

(51) Int. Cl. H04N 5/91; H04N 21/44; H04N 21/81; G11B 20/10

(52) U.S. Cl. CPC H04N 5/91; G11B 20/10; H04N 21/44008; H04N 21/812; G11B 2220/90
USPC 386/249

(57) ABSTRACT

A method and system for tracking playout of auxiliary content (e.g., advertisements) accompanying a digital cinema feature presentation commences by first detecting identifying information in an auxiliary content file associated with the auxiliary content while the auxiliary content undergoes playout. The length of time the detected identifying information remains active is established. Thereafter, both the auxiliary content file(s) and identifying information activity length for which identifying information was detected are logged to track the auxiliary content files that underwent playout.

### CROSS-REFERENCE TO RELATED APPLICATIONS

This application claims priority under 35 U.S.C. 119(e) to U.S. Provisional Patent Application Ser. No. 61/592,674, filed on Jan. 31, 2012, the teachings of which are incorporated herein.

### TECHNICAL FIELD

This invention relates to a technique for tracking the playout of digital cinema compositions.

### BACKGROUND ART

In connection with the presentation of digital cinema to a viewing audience, one or more advertisements typically accompany a feature presentation and any trailers. The Society of Motion Picture and Television Engineers (SMPTE) and the Digital Cinema Initiative (DCI), two standards organizations that develop standards for digital cinema, both use the term “digital cinema composition” to refer to digital cinema content, including feature presentations, advertisement(s) and trailer(s). In practice, advertisements will play-out out ahead of the trailers which playout ahead of the feature presentation. In most instances, the exhibiter (e.g., the theater owner) has ability to reject advertisements included with the trailer(s) and feature presentation. For example, a theater operator that serves a particular brand of soft drink can choose to reject advertisements for competing soft drinks. Further, the theater owner can reject certain advertisements inappropriate for display ahead of a G-rated feature presentation. In some instances, a theater owner can choose to drop a certain percentage of advertisements if a current feature presentation runs late.

By contractual arrangement, advertisers pay for advertisements actually shown and not for advertisements scheduled to play out but do not. Therefore, confirmation of the playout of each advertisement becomes important to both the advertiser and theater operator. Historically, some theatres have relied upon dedicated advertisement players, which use either the same projector as for the feature presentation, or a separate projector dedicated to advertisement playouts. An example of a dedicated advertising player comprises the MS9400 HD FrEND multimedia player module used in conjunction with the ESCAN scheduling system, both manufactured by Electrosonic, Inc. of Burbank, Calif. and deployed by Screenvision Cinema Network, LLC of New York, N.Y. Such systems include the ability to log each advertisement played out by the dedicated advertisement player for subsequent reporting to the advertising broker.

As digital cinema has proliferated, some exhibitors prefer to have advertisements playout from the primary digital cinema projector(s) and the digital cinema server(s) directly, rather than from a separate dedicated player. This approach alleviates some complexity in the interconnection of multiple systems and removes any possibility that the projector or audio subsystems pay attention to the wrong signal source (e.g., playing audio associated with an advertisement instead of playing the audio associated with the feature presentation while the feature presentation undergoes display).

Some digital cinema servers include automatic logging of the playout of digital cinema compositions. Indeed all digital cinema servers that playout encrypted digital cinema compositions must perform logging. However, such logs suffer from:

(a) difficulties in retrieval;

(b) complex and difficult-to-negotiate business agreements between server manufacturers, content owners, and exhibitors, and

(c) the need to generate and distribute unique decryption keys for each such encrypted composition on each digital cinema server.

Accordingly, the use of the existing standardized digital cinema logs remains undesirable for verifying advertising playout. Rather than make use of standardized digital cinema logging systems, many theater operators accomplish digital cinema advertisement playout verification by way of manually generated affidavits (which, as with any manual logging process, appear of questionable precision and accuracy).

Thus, a need exists for a low cost, automatic method to monitor the playout of individual advertisements. In some cases, when incomplete playouts occur, the count should include what fraction of the advertisement underwent playout.

### BRIEF SUMMARY OF THE INVENTION

A method for tracking playout of a digital cinema composition accompanying a digital cinema feature presentation commences by first detecting identifying information in an auxiliary content file associated with the composition while the composition undergoes playout. The identifying information may be specific to the individual auxiliary content file. The length of time the detected identifying information remains active is established. Thereafter, data representing the identifying information and activity length for which identifying information was detected are logged to track the compositions that underwent playout.

### BRIEF SUMMARY OF THE DRAWINGS

FIG. 1 depicts a block schematic of an advertising playout monitor in accordance with a preferred embodiment of the present principles;

FIG. 2 depicts a portion of a digital cinema composition playlist (CPL), in a SMPTE format, having closed caption references for use with the advertising playout monitor of FIG. 1;

FIG. 3 depicts a portion of a timed text track file, in a SMPTE format, referred to in the CPL to provide closed captions for use with the advertising playout monitor of FIG. 1;

FIG. 4 depicts a portion of a resource presentation list (RPL) delivered by a digital cinema server (DCS) to an auxiliary content server (ACS);

FIG. 5 depicts, in flow chart form, the steps of a process for reporting advertisement playout based on logged captions in accordance with the present principles;

FIG. 6 depicts, in flow chart form, an alternative process for reporting advertisement playout based on data representative of reels being logged; and,

FIG. 7 depicts, in flow chart for, yet another process to report advertisement playout based on logged caption interface data; and

FIG. 8 depicts a database schema for logging and reporting advertisement playout based on logged caption interface data in accordance with the present principles.

### DETAILED DESCRIPTION

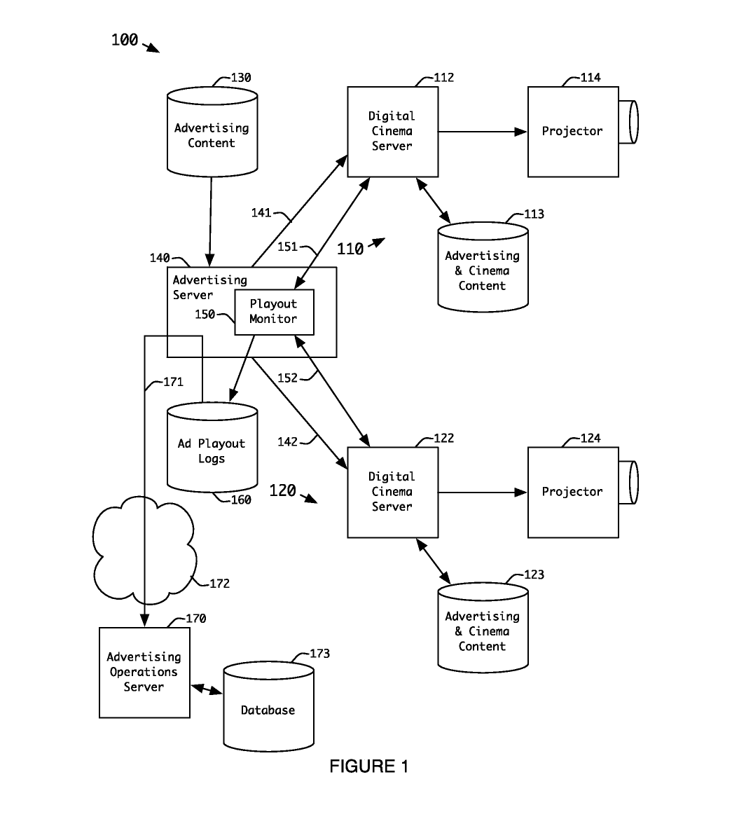

FIG. 1 depicts a digital cinema system 100 for providing playout of digital cinema compositions, including, but not limited to, on-screen advertisements in two distinct digital cinema auditoriums 110 and 120, in accordance with a preferred embodiment of the present principles. Within the auditoriums 110 and 120, digital cinema servers 112 and 122, respectively, each communicate with content storage devices 113 and 123, respectively, and with digital projectors 114 and 124, respectively. As well known in the art, for some embodiments, the digital cinema server (e.g., 112) may be integrated with the corresponding projector (e.g., 114). The content storage devices 113 and 123 store advertising content and cinema content, for example, feature presentations and trailers, all being digital cinema compositions and typically provided as digital cinema composition playlists (CPLs) or in other appropriate formats. The following discussion will primarily focus on an exemplary system having content (digital cinema compositions) provided in CPLs in a format corresponding to the appropriate SMPTE standards. However, the logging of advertisements in accordance with the present principles need not require the CPLs formatted in accordance with the SMPTE standards.

An advertising server 140 receives advertising content 130 from a remote source, for example a hard drive or other physical storage medium in communication with the advertising server. Alternatively, or in addition to the content received from one or more physical storage devices, the advertising server 140 can also receive the advertising content 130 over a communication link (not shown), for example via satellite, a broadband link, a wireless connection or otherwise, from a source for such content (not shown). In this embodiment, the advertising server 140 communicates with the digital cinema servers 112 and 122 through channels 141 and 142, respectively, to deliver at least a portion of the advertising content 130 to each digital cinema server, for ingest by and storage in, the content storage devices 113 and 123, respectively.

In practice, the advertising server 140 has a playout monitor module 150 in communication with the digital cinema servers 112 and 122 through channels 151 and 152, respectively, for monitoring the playout of digital cinema compositions, and particularly, the playout of advertisements, by each server. As described in detail hereinafter, the playout monitor module 150 monitors the resource presentation lists (RPLs), captions, reel usage, and/or the current feature presentation timeline to facilitate the logging of the playout of one or more digital cinema compositions, and particularly, advertisements.

In digital cinema systems, such as the digital cinema system 100 of FIG. 1, a digital cinema server (DCS), such as one of the digital cinema servers 112 and 122 can generate captions or subtitles for display by a subsystem (not shown) other than a one of the corresponding digital cinema projectors 114 and 124 of FIG. 1. Such a caption or subtitle display subsystem will bear the designation “auxiliary content server (ACS)” in subsequent discussion.

Technically, the term “captions” refer to text corresponding to the dialog, in the same language as the spoken dialog, whereas “subtitles” refer to text corresponding to the dialog, but in a language other than the spoken dialog. “Open subtitles” typically appear on the main presentation screen for viewing by the entire audience. In contrast, “closed subtitles” or “closed captions” only appear to those electing to view them, for example by using an apparatus to make the closed captions/subtitles visible. Hereafter, the terms “subtitles” and “captions” appear interchangeably, and refer to the “closed” versions thereof.

The Society for Motion Picture and Television Engineers (SMPTE) has developed an exemplary standardized mechanism for DCS/ACS interaction embodied in one or more SMPTE standards to promote interoperability. The SMPTE standards for closed subtitles and/or closed captions in digital cinema allow alternative language subtitles, or same-language captions (e.g., for those hard of hearing) during the playout of a feature presentation. Further, such standards provide a means for encoding such captions/subtitles and a protocol to allow an Auxiliary Content Server (ACS) to communicate with a Digital Cinema Server (DCS) such as one of digital cinema servers 112 and 122 of FIG. 1, via Internet Protocol (IP protocol), for example over Ethernet. The SMPTE “Auxiliary Content Synchronization Protocol” informs an external ACS where to obtain a list of available caption/subtitle languages (an “Auxiliary Resource Presentation List,” or RPL), which in turn, identifies files containing the individual captions and their associated position within the timeline. The Auxiliary Content Synchronization Protocol also provides the timeline's current position while the DCS plays out the presentation.

Thus, the ACS acquires the RPL and then the ACS acquires one or more language-specific files of interest containing the associated captions/subtitles. The ACS further tracks the progress of the timeline as the presentation plays, and displays the captions of interest in synchronization with feature playout, as appropriate. Should the DCS stop or skip forward or backward, the synchronization protocol reports that the timeline has stopped or skipped. Captions associated with a backwards skip can undergo playout again, while those associated with a forward skipped interval do not play.

Complete details regarding the encoding of closed captions and closed subtitles for use in a digital cinema presentation, and the Auxiliary Content Synchronization Protocol and Auxiliary Resource Presentation List appear in the following SMPTE standards:
SMPTE ST 428-10:2008 D-Cinema Distribution Master—Closed Caption and Closed Subtitle;
SMPTE ST 429-7:2006 D-Cinema Packaging—Composition Playlist;

SMPTE ST 429-12:2008 D-Cinema Packaging—Caption and Closed Subtitle;
SMPTE ST 430-10:2010 D-Cinema Operations—Auxiliary Content Synchronization Protocol; and,
SMPTE ST 430-11:2010 D-Cinema Operations—Auxiliary Resource Presentation List.
   Other closed caption/subtitle mechanisms exist and find application in digital cinema systems, for example the Rear Window® captioning system, developed by The Media Access Group at WGBH, Boston, Mass. and taught by Seder et al., in U.S. Pat. No. 5,570,944.

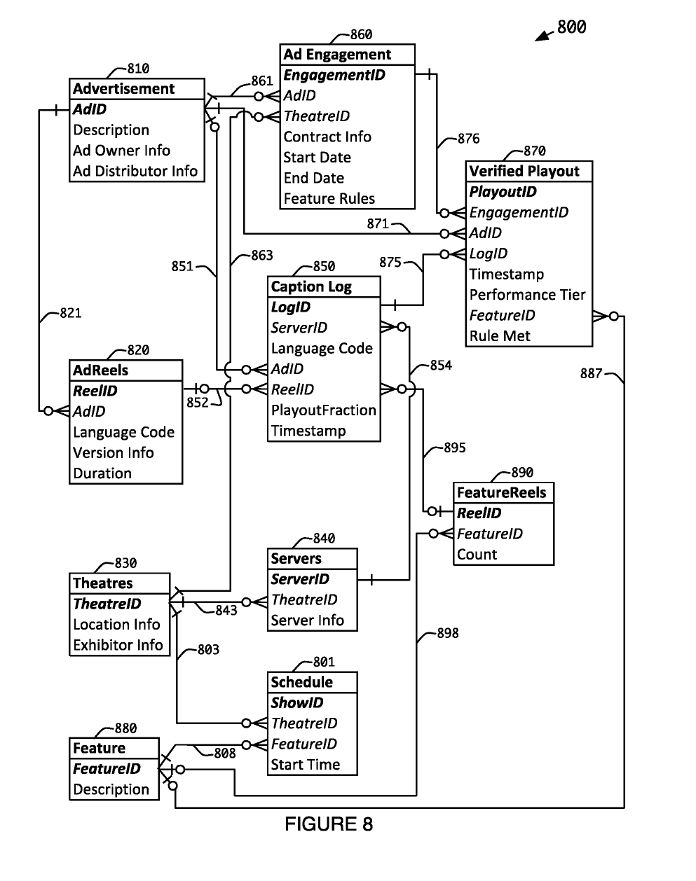

As described hereinafter, the playout monitor module 150 produces advertisement playout logs 160 by tracking captions associated with advertisements undergoing playout. The playout monitor module 150 can communicate such logs to an advertising operations server 170 by a communication channel 171, which may comprise the Internet 172, and/or an intranet. The advertising operations server 170 can employ a database 173 to track which advertisements should have played and to collect and organize the verification information reported by the playout monitor module 150. A more detailed discussion of the database 173 appears hereinafter in conjunction with FIG. 8.

In alternative embodiments, the playout monitor module 150 can reside external to the advertising server 140. Alternatively, each of the digital cinema servers 112 and 122 could have its own associated playout monitor module (not shown). Further, the playout monitor module 150 could lie external to the exhibition facility, and the channel 151 could comprise a connection through Internet 172 and/or a virtual private network (VPN) connection (not shown). Thus, in some embodiments (not shown), the playout monitor module 150 could comprise a component of, or lie collocated with, the advertising operations server 170. The logs 160 can undergo storage for several days or weeks and/or undergo transmission to one or remote locations in a batch. Alternatively, the playout monitor module 150 could write the logs 160 onto a physical media for shipping rather than send the logs via electronic transmission using a communication channel (e.g., the channel 171).

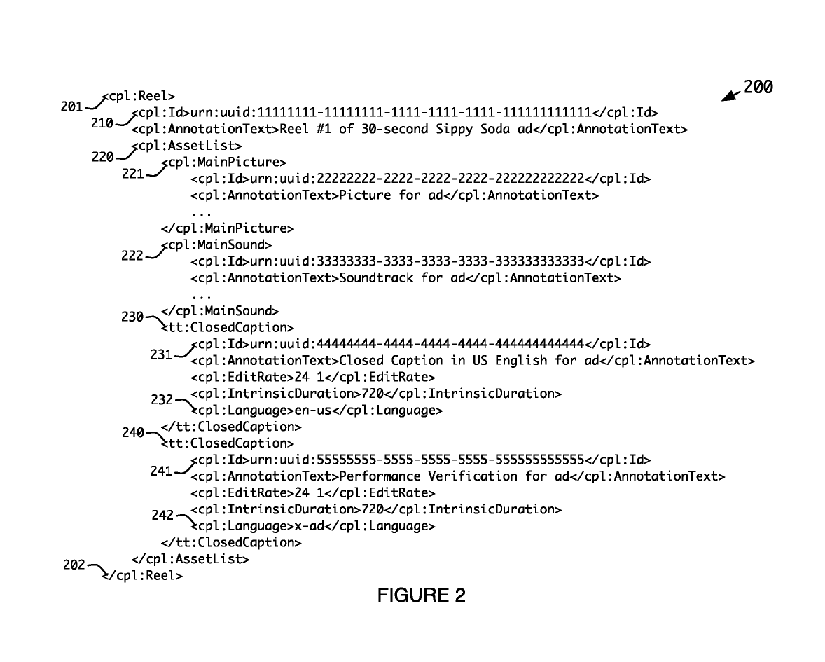

FIG. 2 shows a portion 200 of a Composition Play List (CPL) file, in the SMPTE format, identifying the media assets for use in the presentation of all or part of a digital cinema composition. Many digital cinema compositions, especially advertisements and trailers are organized as a single “reel” (a unit of organization typically not exceeding 20 minutes, and having its origins in film-based content), whereas most feature presentations comprise of multiple reels, typically five or more.

The Composition Play List or CPL constitutes a type of XML (eXtensible Markup Language) document and contains hierarchically nested elements bounded by tags called out by angle brackets, as depicted in FIG. 2. The reel element represented by the portion 200 begins at an opening reel tag 201 and runs through a closing reel tag 202. Each reel has a globally unique identifier 210. Each reel of a CPL has a list of assets. For reel 210, the asset list 220 contains the following four elements:
the main picture portion 221,
the main sound portion 222,
a first closed caption 230 having globally unique identifier 231 and a language tag 232 indicating U.S. English, and
a second closed caption 240 having globally unique identifier 241 and a language tag 242 indicating “x-ad”, in this example an unregistered “experimental” tag used to identify ad verification captions.
   Ellipses (“ . . . ”) in the figures indicate details omitted for brevity in these examples, but otherwise remain well known to those in the art.

Each asset tag in list 220 can have an association with a corresponding asset track file that has a corresponding global identifier. The main picture portion 221 and the main sound portion 222 identify files containing a series of images representing the feature presentation, and the corresponding multi-channel audio for simultaneous playout with the feature presentation, respectively. The closed caption 230 identifies a timed-text file that includes captions (in English) and the timer interval during which each caption can undergo display.

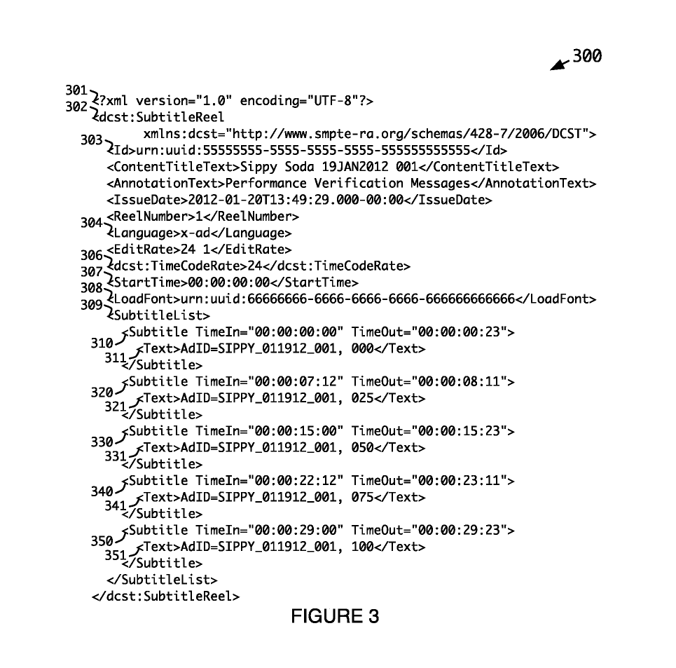

Referring to FIG. 3, the closed caption element 240 identifies the timed-text file 300 with an identification (ID) tag 241. The timed-text file 300 begins with an XML header 301, then a frame, with the remaining content comprising a “digital cinema subtitle” (DCST) element 302 having a globally unique identifier 30. The closed caption element 240 in CPL reel 200 has an identifying tag 241. The “Content Title Text” and “Annotation Text” tags and others that follow provide human readable information. The language tag 304 indicates “x-ad,” which as described above, does not constitute a language tag in previous use and does not represent an actual language, but in the present example, serves to indicate closed captions provided for use in advertising playout verification.

The individual captions in the timed-text file 300 appear in a sequential list in the “Subtitle List” element 309. Each of the subtitle elements 310, 320, 330, 340, and 350 provides a time-in (at which the subtitle first applies), a time-out (at which the subtitle last applies), and the text of the individual subtitles 311, 321, 331, 341, and 351, respectively. Since the timed-text file 300 bears the designation “x-ad,” the individual caption texts generally do not undergo presentation to the audience, but instead provide an identification of the advertisement (“SIPPY_{—}011912_{—}001”) and a percentage indicator (e.g., “000” in subtitle text 311 representing 0%) that announces what fraction of the reel 210 has played as of the corresponding time-in. The timecodes representing time-in and time-out have the following format:

hours:minutes:seconds:frames,

with the number of frames per second identified by a time code rate tag 306, which can be offset by a start time tag 307.

According to the subtitle element 310, which could undergo display during the first 24 frames of the advertisement represented by reel 201 in CPL 200, the closed caption will indicate that 0% of the advertisement (identified as “SIPPY_{—}011912_{—}001”) has played out, whereas by the time subtitle element 330 applies (beginning at 15 seconds), 50% of the advertisement has played out. Each of the captions, in this example, applies for one second.

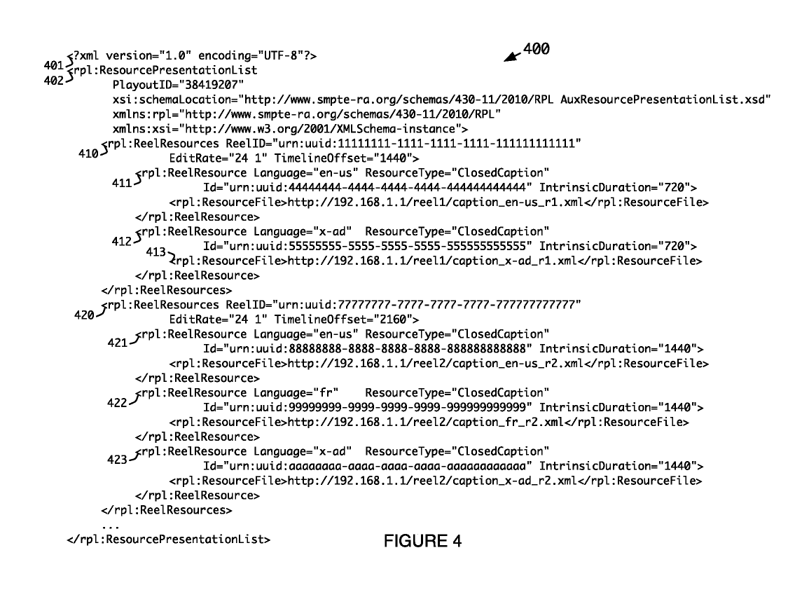

The schema definition for a SMPTE subtitle track file requires the “Load Font” tag 308 but no need exists to reference the font's globally unique identifier in the verification of the playout for the advertisement represented by reel 201. In this exemplary embodiment, and according to the SMPTE standards, access to closed captions such as those in the subtitle list 309 occurs by an auxiliary content server or ACS (here, the playout monitor module 150) registering with a digital cinema server (e.g., the server 112) using the auxiliary content synchronization protocol (as defined by the SMPTE reference above). Once registered, the playout monitor module 150 receives an address at which to find the resource presentation list file 400, shown in FIG. 4 at the start of playout by the digital cinema server 112. The playout monitor module 150 retrieves a presentation list file 400 and by parsing this file, the playout monitor learns of the advertisement playout verification files 412 and 423 (the two reel resource tags attributed with language “x-ad”) in each of corresponding reel resources elements 410 and 420, respectively.

Reel resource element 410 also lists an English-language closed captions asset 411. The reel resource element 420 lists an English-language closed captions asset 421 as well as a French-language closed captions asset 422. Each reel resource element has an identification, for example, the reel resource 412 contains the global unique identifier “urn:uuid:55555555-5555-5555-5555-555555555555” corresponding to the identifier 303 in the timed-text file 300. Each reel resource also presents a resource file location 413 identifying the location for retrieving the file 300, generally (though not necessarily) by using the hypertext transfer protocol, and generally (though not necessarily) from a server offered by the digital cinema server, in this example reachable at local internet protocol (IP) address “192.168.1.1”.

In the exemplary embodiment of FIG. 1, the digital cinema server 112 communicates with the playout monitor module 150 over the Ethernet connection 151 using the auxiliary content synchronization protocol. In this way, the digital cinema server 112 can direct the playout monitor module 150 to retrieve the resource presentation list 400 and allow subsequent retrieval of the timed-text file 300, both via the connection 151. The address provided in the universal resource locator (URL) in the element 413, identifies the digital cinema server 112 accessible via the connection 151. The digital cinema server 112 provides the subdirectories and filenames of the resource file as the server sees fit. In other words, the digital cinema server 112 arbitrarily determines the folders and filenames with reference to the timed-text file 300.

In accordance with the auxiliary content synchronization protocol, the digital cinema server 112 subsequently indicates to the playout monitor module 150 the current position (in edit units) and status (e.g., playing vs. paused) of the presentation corresponding to the resource presentation list 400. Edit units constitute the smallest units of time for measuring a digital cinema composition. In the case of the presentation corresponding to RPL 400, both reels 410 and 420 have edit rates of “24 1”, or 24 edit units per 1 second. Individual reels could have different edit rates, and the elements in the RPL 400 do not always represent all reels in a feature presentation (only those with closed caption or closed subtitle tracks). Thus, where reel resources element 410 cites a Timeline Offset of “1440,”, that means that the contents of the reel 201 (having the identity 210 corresponding to that in reel 410) will start at “1440” edit units into the current presentation. At an edit rate of “24 1”, this would constitute sixty seconds in accordance with the relationship 1440/24=60, where at any given time the current the auxiliary content synchronization protocol supplies the edit rate to the playout monitor module 150 used for the reel(s) that play out prior to reel 201.

When the current position of the presentation reported by the digital cinema server 112 reaches “1440”, that is the time when reel resource elements 411 and 412 become current, and within timed-text file 300 (since it is identified by the Id element of reel resource 412), the first subtitle element 310 becomes active. The start time 307 is 00:00:00:00 and the time-in for subtitle element 310 is 00:00:00:00), and the subtitle element remains active for twenty-four edit units, which here constitutes one second.

While subtitle element 310 remains active, the playout monitor module 150 can obtain from the closed caption text 311 an indication that the advertisement identified as “SIPPY_{—}011912_{—}001” played out 0%. Fifteen seconds (360 edit units) later, assuming the playout continues, the caption 331 indicates 50%, playout and at twenty-nine seconds into the playout, the caption text 351 indicates the playout of the advertisement has reached 100%. In some embodiments, omission of the playout percentage can occur, along with some of the subtitle elements 310, 320, 330, 340, and 350. For example, depending on business policies, the playout monitor module 150 may not care about the 0% or 25% playout marks, or perhaps anything less than 100% playout. During a particular presentation, the time at which each caption in file 300 becomes active can undergo logging, or alternatively, only the caption marking the most complete playout would require logging. For example, if advertisement 300 played out up to 80% and was then stopped, then for that playout, logging of the caption 341 would occur, but logging of the caption 351 would not occur). In still other embodiments, logging of playout can comprise a count incremented for each caption of interest.

In an alternative embodiment, rather than requiring a special “x-ad” caption file, the system 100 of FIG. 1 can rely on the “en-us” or other ordinary language captions (e.g., as referenced in the CPL 200 by the closed caption asset element 230 and in the RPL 400 by the reel resource element 411, but otherwise not shown). In such a case, the active last caption entry could undergo logging. In an alternative embodiment, each consecutive caption within the entire reel could be hashed to a single value, thereby representing a value indicating whether the advertisement had played completely with little chance of ambiguity. This approach affords the advantage of obviating the need to duplicate text assets from the close caption track file, thereby avoiding copyright issues that might otherwise arise.

In some embodiments, the playout monitor module 150 could choose to disregard the captions in subtitle list element 309, or the corresponding subtitle list element in the normal language caption file(s) referenced by elements 230 and 411. Instead, the playout monitor module 150 could determine the fraction of playout directly from the RPL and the reported playout position. For instance, when the playout monitor module 150 has identified reel 201 at reel 410 in RPL file 400 as beginning at timeline offset “1440” and the reel resource elements 411, 412 are each identified as having an intrinsic duration of “720” edit units (the “IntrinsicDuration” attribute is mandatory under the SMPTE standard, but, when present, the optional “Duration” attribute—not shown—should be used instead), then the current fraction of playout for the advertisement represented by reel 201 can be determined as the current position less the timeline offset (“1440”) divided by the intrinsic duration (“720”). For example, at timeline position “1800,” which would occur while the advertisement reel 201 plays out, the fraction of the advertisement having played out would be: (1800−1440)/720=360/720=50%. In this embodiment, reel identifier 210 (and called out in the RPL at 410) could serve to identify which advertisement played out during the logging process.

The log could undergo updating whenever playout is halted (which might represent the interruption of an advertisement) and at the end of each reel through which playout proceeds. In this way, advertisements that play through to completion are logged at the reel boundaries, and advertisements that are interrupted (even if subsequently resumed) may be noted. How such logs are interpreted when reported (e.g., whether fractional playout is reported, or at what fraction of playout of an advertisement is considered to have played) remains a business policy.

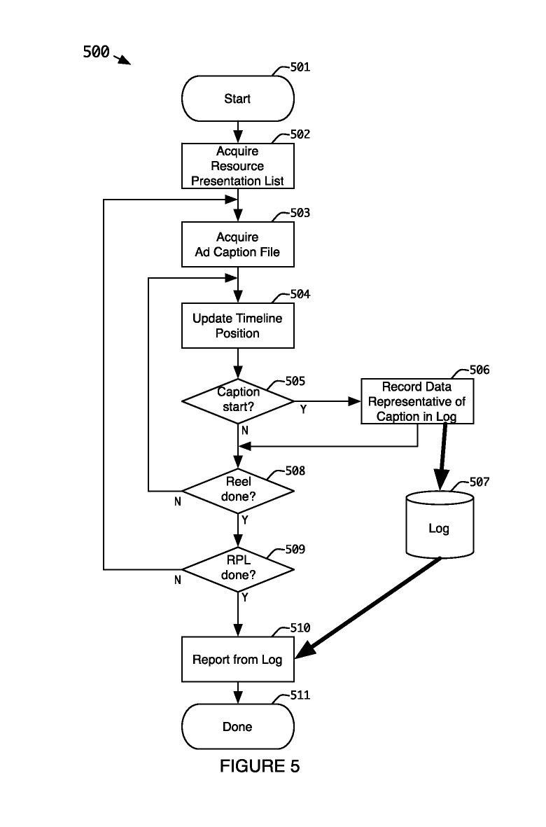

FIG. 5 depicts, in flow chart form, one embodiment of an advertisement playout reporting process 500, which starts at step 501 with the playout monitor module 150 communicating with the digital cinema server 112. The communication follows the playout monitor module 150 and digital cinema server initiating a connection by a request for, and the granting of, a lease via the auxiliary content synchronization protocol with a show ready to play or already playing. At step 502, the digital cinema server 112 provides a resource presentation list (RPL), e.g., the list 400, to the playout monitor module 150. The RPL 400 lists one or more reels (e.g., reels 410, 420) having auxiliary content (in this example, closed captions) corresponding to content (e.g., advertisements) whose playout the playout monitor module 150 monitors to identify the closed caption files (e.g., the files 412, 423) corresponding to those reels. At step 503, the playout monitor module 150 retrieves a closed caption file (e.g., 300) identified in the RPL 400 corresponding to content to undergo monitoring. The playout monitor module 150 can parse the file to determine at what timeline position (in edit units) each subtitle becomes active.

Generally, the first closed caption file (e.g., the file 300) retrieved at step 503 will correspond to the file (e.g., the file 412) listed in the first reel indicated (e.g., reel 410) in the RPL (e.g., the RPL 400). The playout monitor module could retrieve additional closed caption files (e.g., 423) sequentially or in parallel. However, in some cases where the presentation begins at a position other than the start, or where playout skips forward to a later position shortly after beginning, then the first closed caption file retrieved could be other than the first one (300).

At step 504, the playout monitor module 150 updates its estimate of the playout position. The playout monitor module 150 may update this playout position estimate once for each edit unit, such that a continuous series of edit unit counts are provided by iterations of step 504. Periodically, while playing, the digital cinema server 112 will send an update including the current playout position, and the playout monitor module 150 uses the update to recalibrate its count and ensure synchronization. When playout begins, pauses, or resumes, the digital cinema server sends an update substantially immediately, as prescribed by the auxiliary content synchronization protocol.

At step 505, a comparison occurs to determine whether the current timeline position (e.g., “1800”) corresponds to a reel (e.g., reel 410, running from “1400” through “2159”) in the RPL (e.g., the RPL 400) to determine whether the current timeline (playout) position matches any captions in the RPL. If so, then the corresponding caption file (e.g., file 300) from step 503 undergoes examination to determine which, if any, of its captions (e.g., captions 310, 320, 330, 340, and 350) corresponds to the current timeline position (e.g., (1800−1440)/24=360/24=“00:00:15:00”), as caption 330 in timed-text file 300 having a time-in of “00:00:15:00” does.

If at step 505, there is either no previously active caption or a previously active caption has, as of this current position, just become inactive, and a new caption (such as caption 330 in the example) has just become active, then processing continues at step 506. During step 506, the database 507 logs data representative of the caption text (e.g., text 331) for later reporting, after which the process continues to step 508 to await the next timeline increment. Otherwise, when no caption has just become active (whether or not there is a previously active caption), processing continues at step 508.

Different embodiments can log different representations of the caption undergoing recording at the step 506. In some embodiments, the text of the caption can undergo recording as-is, (e.g., as found within the text tags 331). In other embodiments, the caption may be parsed, e.g., to separate the AdID field and the percentile completion into distinct record fields. A timestamp representing the current date and time might also be introduced as a field in such a record. In still other embodiments, a single record could be created for each playout of an advertisement, with a single instance of the Advertisement Identification (AdID) and only the most recent percentile completion. Further, there might be a count field that is incremented when a playout fraction has substantially achieved 100%. Such summary data can be very compact and might be reset periodically, for example upon confirmation that the prior count has been reported and receipt confirmed. In still other embodiments, the playout monitor module 150 could encrypt or hash the record to better resist fraud.

At step 508, a test occurs to determine whether the portion of current caption file (e.g., the caption 300) called out in the RPL (e.g., RPL 400) has been exhausted. If not, processing continues back to step 504 to await the next timeline update. If the caption file is exhausted, then processing continues at step 509. Note that an RPL need not use the caption file in its entirety, since in some instances (none shown, but documented in the SMPTE specification for the RPL), a reel resource (e.g., 412) could have an entry point and/or duration that would specify only a portion of the timeline defined within the subtitle file (e.g., file 300) for use, including specifying only a portion of an individual caption.

At step 509, a comparison occurs between the current position in the timeline and the overall RPL to determine whether the RPL has been exhausted. If not, processing continues at step 503 with retrieval of the next caption file (e.g., as referenced by file 423). Note that in some embodiments, this file could have been pre-fetched and pre-parsed, as a background process, so as to be immediately ready at this point. However, if at step 509 the RPL has been exhausted, then the playout has completed and the process proceeds to step 510, where information stored in the log undergoes processing for reporting, for example to the advertising operations server 170. In some embodiments, reporting on logs can occur in real time, or stored over many performances (e.g., for hours, days, weeks) and sent as a whole, or in summary, by direct connection, or indirectly (e.g., via email), or made available for downloading or recall and inspection via web server, etc. In some embodiments, the log entries in database 507 can be submitted as records in a larger database and the report being provided on an ad-hoc basis. Upon completion of reporting, the process 500 concludes at step 511.

In some embodiments, monitoring and logging of the trailers and feature that play among or after the advertisements can also occur in a similar manner. For such embodiments, at step 503, acquisition of the caption files corresponding to trailer and feature content occurs in a similar manner, though these caption files may lack special markers (e.g., a special language code like “x-ad”). For example, some trailer producers can incorporate special markers to make playout monitoring simple and reliable (as discussed above), but the feature presentations, since they are typically encrypted, undergo logging by the digital cinema security components. However, such logs generally remain inaccessible by parties other than feature distributer and/or owner. In these instances, one can infer the identity of the feature from a correlation between repeat occurrences of unique subtitle data (as recorded during step 506) and show schedules published elsewhere. This is discussed in greater detail in conjunction with FIG. 8, below.

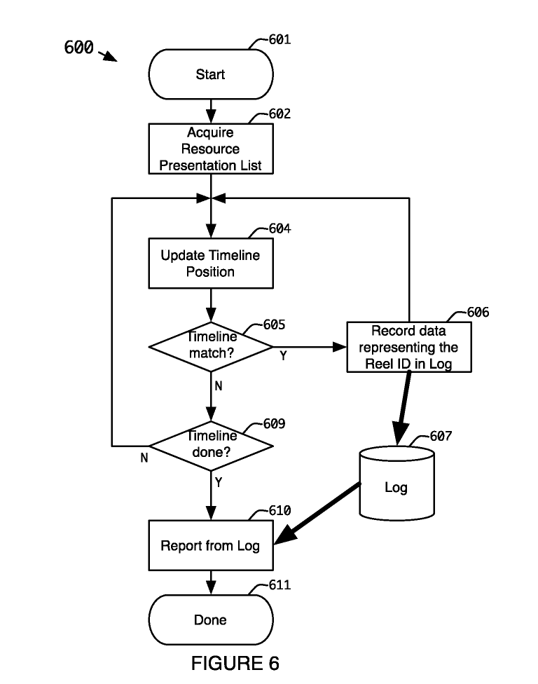

FIG. 6 shows another exemplary advertisement playout verification process 600 for execution by a playout monitor module (e.g., the playout monitor module 150); wherein steps 601, 602, and 604 perform substantially the same function as the steps 501, 502, and 504 of FIG. 5, respectively. However, at step 605, a test occurs to determine with which reel, if any, of the RPL 400 corresponds to the current timeline position. If one does correspond, then at step 606, the reel identity (e.g., “11111111-1111-1111-1111-111111111111” from tag 410) undergoes recording in the database 607, along with the current playout fraction (e.g., if the current timeline position is “1800,” then 1800−1440)/720=50% based on the timeline offset and intrinsic duration (or actual duration, if provided) of the associated reel resources. In some embodiments, the logging of the reel playout during step 606 could await the playout fraction exceeding some predetermined value (e.g., 95%).

At step 609, a test occurs to determine whether the timeline represented by the RPL is complete. If not, process 600 reverts to step 604. Otherwise, at step 610, access of the database 607 occurs to provide a report to verify advertisement playout. Once the playout has been verified at step 610, process 600 concludes at step 611.

Note that in both cases of FIGS. 5 and 6, if a CPL has no auxiliary content (e.g., closed caption) assets, then the RPL 400 will have no representation of that CPL, nor will there be corresponding timed-text files accessible using the auxiliary content synchronization protocol. Certainly, for advertising, the entity that is packaging the advertisements for distribution into this system will control CPLs, and by extension, when they are selected and schedule for playout, their inclusion in the RPL 400. As for other content, for example features, there is a substantial likelihood a legal requirement will exist to provide such auxiliary content (e.g., captions) to assure sufficient accessibility, for example for the hearing impaired, or be the least intrusive of accessibility methods meeting the requirements for such a law.

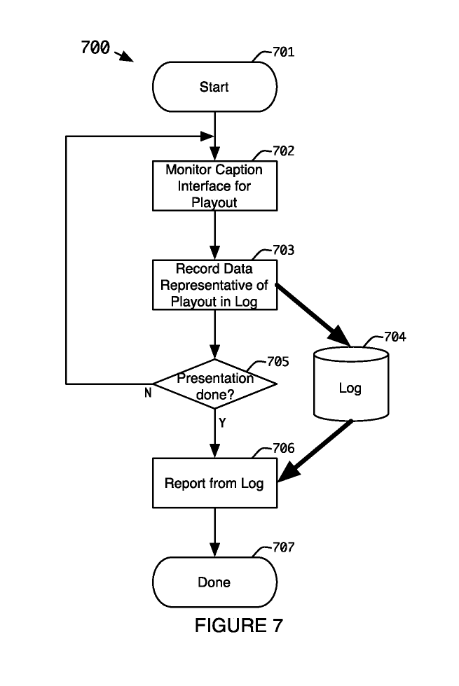

FIG. 7 shows an advertisement playout monitoring process 700 for execution by a playout monitor (e.g., the playout monitor module 150), in which step 701 performs substantially similar functions to steps 501 and 601. At step 702, the playout monitor module 150 checks the caption interface (e.g., the connection 151 to the corresponding digital cinema server 112) to detect advertisement playout as described above with respect to FIGS. 5 and 6. At step 703, the playout monitor module 150 records each advertisement playout detected at step 702 in a database 704. At step 705, a test occurs to determine whether the presentation has completed, and if not, processing resumes at step 702. Otherwise, at step 706, the database 704 undergoes access to provide a report and the process concludes at step 707.

Upon completion of any of monitoring processes 500, 600, 700, the playout monitor (e.g., module 150) may start (or already may have started) a next instance of the monitoring process so as to monitor the next presentation as represented by the next RPL provided by digital cinema server 112.

FIG. 8 shows an exemplary schema 800 suitable for implementing the database 173 for use by the advertising operations server 170. Each record in each table has an identity field (in bold-italics) which uniquely identifies that record. Some foreign-key fields (field names indicated by non-bold-italics) create relationships with records in other tables useful for resolving certain queries and producing comprehensive reports (e.g., which advertisements have played in which theatres at which performance tier, which according to contract information may be used to determine how much money an advertiser is to be billed).

In schema 800, an advertisement table 810 records individual advertisements (e.g., a particular advertisement for soda). The advertisement identifier key field associated with each record in advertisement table 810 serves as a uniquely identifier for that record. Each advertisement has a corresponding description field describing that advertisement. The description can include a reference to actual advertisement content (not otherwise shown here). The description field can include other information, such as the advertisement owner and advertisement distributor, needed for booking or billing for such advertisements.

The agency packaging the advertisements for playout by digital cinema systems can populate the advertisement reels table 820. If so, then the reel ID (e.g., reel ID 210) or in the alternative, the closed caption identifier (e.g., close caption identifiers 241 and 303) becomes noted, in conjunction with the corresponding advertisement identifier, which generates relationship 821, whereby the reel identifier ties back to a particular advertisement record. Note that multiple advertisement reel records can exist in the table 820 for each advertisement. For example, a single advertisement record in table 810 might correspond to two pieces of content: For example, the same advertisement could exist in each of two aspect ratios (scope and flat), each well suited for playout with a feature having the corresponding aspect ratio. Each advertisement reel record can include other information, for example, the language code, version information, and duration.

In the theatres table 830, each record corresponds to a theatre which may be under contract to playout one or more advertisements. The theatre identification key field uniquely identifies each theatre record. Some embodiments can further identify individual auditoriums within each theatre, but this can lead to unacceptably high churn in the database that may result in too many records not synchronized with the reality they are supposed to represent. Other information in the theatres table 830 can include location information, as necessary for example to determine the address for shipping content or whether the theatre resides in a particular demographic region, and exhibitor information, for example as needed to contact responsible personnel, or for determining common administration of multiple theatres.

The servers table 840 contains a record for each digital cinema server known to the system 100. Each server record in 840 has a unique association with a single theatre as given by a relationship 843. The server information can include a unique device identification, or an association with a particular playout monitor module 150 or a communication channel 151 to facilitate recording or constructing an association between records in logs 507, 607, and 707, and particular theatres. Each record in logs 507, 607, and 707 can have a corresponding record in the caption log table 850. The caption log table 850 can reside the in advertisement playout log 160 at multiple theatres and subsequently consolidated into the database 173. Alternatively, the database 173 can undergo updating in substantially real time (i.e., up to the second, or hour, etc.). In some embodiments, the logs 507, 607, and 707 would periodically undergo transfer to the advertising operations server 170 for ingestion (and processing as necessary) to populate the table 850.

Each log record in table 850 has a unique log identifier. The server identifier and its corresponding record form relationship 854. In the case of the caption-based process 500, the advertisement identifier resides in the text of each caption (e.g., the caption 331) and can form relationship 851. In the case of the reel-based process 600, the reel identifier (e.g., from reel 410 or in some embodiments, the timed-text identifier (e.g., the timed-text identifiers 411, 412, or 303) undergoes capture to form a relationship 852, for subsequent combination with the relationship 821 to populate the advertisement identifier and form relationship 851.

The playout fraction and timestamp fields indicate what portion of the advertisement had played, and when. The playout fraction can serve to validate playout as having met contractual or business requirements (e.g., the advertisement playout occurs only if the logging indicates the playout fraction at or above 95%). The timestamp can serve to determine the proximity of the advertisement to the feature presentation in accordance with contractual or business requirements (e.g., the advertisement was one of the last five played before the feature, or the advertisement played within five minutes prior to the feature, etc.).

The advertisement engagement table 860 contains records associating individual advertisements to contractual or business agreements that govern advertisement playouts. In this exemplary embodiment, fulfillment of an advertisement engagement record in table 860 occurs by the corresponding advertisement playing out one or more times between the start date and end date according to the contract info field. If the qualified playout of the advertisement must occur within a predetermined proximity to an arbitrary feature, or a particular feature, or any feature but a particular feature, then such requirements will reside in the feature rules field. The particular advertisement and theatre to which such advertisement engagements apply produce the relationships 861 and 863, respectively. In an alternative embodiment, a collection of advertisements or a collection of theatres might be associated with a single engagement record, for example through intermediate linking records (none shown) forming many-to-many relationships in lieu of either or both 861 and 863. The engagement identifier uniquely identifies the advertisement engagement records.

The verified playout table 870 includes of records that indicate a log record in table 850 (determined through the relationship 875), the corresponding advertisement (determined through the relationship 871), and the advertisement engagement record to which the verification record applies (determined through the relationship 876). The verification record can include the timestamp for the advertisement playout time, a performance tier (i.e., a quantized indication of how close the playout advertisement occurred relative to the start time of the feature), the associated feature (determined through the relationship 887), and the evaluation results of compliance with the applicable feature rules. The verified playout records from table 870 can serve to drive a billing system (not shown) for billing the owners or distributers of the corresponding advertisement. In one exemplary embodiment, the “quantized indication” that makes up the performance tier field could constitute a predetermined, three-tier scale indicating whether the advertisement plays within five minutes of feature start, within ten minutes, or longer before. Different predetermined tiers could exist for each advertisement engagement record in the table 860, and selected or otherwise indicated by the contract information field.

For some embodiments, the feature table 880 can include an identifier for each feature known to the system 100 of FIG. 1. The description field can contain the title of the feature, and/or other identifying information. The feature rules field in advertisement engagement table 860 can include references to features in the records of table 880 (for which no relationships appear). Two exemplary mechanisms for identifying the start time of a feature in table 880 appear separately in the feature reels table 890 and the schedule table 801. The feature reels table 890 presumes generation of a log record in table 850 for an unrecognized reel, that is, one for which no corresponding advertisement reel record exists in the table 820. Upon generation of such a log record lacking a corresponding reel identifier in the advertisement reels table 820, a search may be made for a corresponding reel identifier in the table 890. Upon finding no corresponding reel identifier, then a record with the reel identifier gets created, forming relationship 895, and the count field is set to ‘1’, but if a record in the feature reels table 890 already exists, then the reference count field is incremented. The relationship 898, associating the reel identifiers with the feature records in table 880 can pre-exist. For example, the system can provide the reelID corresponding to a particular featurelD in advance, or populate the field subsequently (e.g., because of later receipt of the data or because of generation of the data from a sufficient correspondence with records in the schedule table 801).

An example of how such a ‘sufficient correspondence’ might be established starts with movie schedules encoded into the schedule table 801, which contains a record for each theatrical exhibition. Each record has a ShowID field uniquely identifies each theatrical exhibition. Further, each record has fields to describe a particular theatre (determined by the relationship 803) scheduled to present a particular feature (determined by the relationship 808) at a particular time (the start time). Each such scheduled show record can correspond to a log record in the table 850 associated with no advertisement reel (relation 852 is null). Each such schedule show record will have an association with the same theatre through the two relationships 854 and 843. In other words, the log record in 850, determined by the relationship 854, originates a particular server. That server resides in a particular theater determined by the relationship 843. The timestamp for the record in 850 lies within 20 minutes or so from the start time of the scheduled show record in 801.

A scheduled showing can become subject to last minute changes (e.g., cancellation, moving or delay of a scheduled showing). Further, uncertainty can exist regarding the auditorium in a theatre to which schedule record applies. For at least these reasons, the system 100 can build the association 898 upon the peak correlation between the start times (in table 801) associated with a single feature (in table 880, by relationship 808) and the timestamps in table 850 associated with a single reel ID (in table 890 by relationship 895). The highest correlation (over multiple theatres and perhaps over multiple days) occurs because the non-advertisement reelID in table 850 constitutes the first reel of the featurelD from table 880. Regardless of the manner of determining the feature-reel association, the association 898 is recorded in the table 890 for subsequent evaluation of the performance tier and compliance with the feature rules, as stored in verified playout table 870.

Other mechanisms could serve to associate feature reels or scheduled shows with particular features, for example by accessing and parsing the CPL corresponding to the feature, or by obtaining and parsing logs of secured feature playout from the digital cinema server (e.g., the server 112). Any of such mechanisms could determine which feature correspondingly follows (within, say, not more than 30 minutes) each of the advertisement caption logs of table 850, for the ultimate use in populating the feature identity field in the verified playout records of table 870 and the establishment of relationship 887.

Certainly, other database structures could serve the same function as the exemplary schema 800 for use in practicing the present principles. While the exemplary embodiment describes a relational database, those skilled in the art will recognize from the present teachings that other paradigms could successfully provide the same results. Thus, the auxiliary content (e.g., closed caption) interface of a digital cinema server could serve to verify the playout of advertisements for the purpose of reporting and billing. Such a system might also be used to verify trailer playout, in cases where that would be desirable.

1. A method for tracking playout of a first digital cinema composition, comprising the steps of:
a) detecting first identifying information corresponding to first auxiliary content while the first digital cinema composition undergoes playout, the identifying information specific to one of the first digital cinema composition, a reel of the first digital cinema composition, an auxiliary content file comprising the first auxiliary content, and at least a portion of the first auxiliary content;
b) logging first data representative of the composition having played based on the identifying information.

2. The method of claim 1 further comprising the step of:
c) establishing from at least the identifying information that a particular fraction of the first digital cinema composition has played; and,
wherein the data is further representative of the particular fraction.

3. The method of claim 1 further comprising the step of:
c) establishing from at least the identifying information that a particular fraction of the first digital cinema composition has played; and,
wherein the logging step occurs in response to the particular fraction being at least a predetermined fraction of the first digital cinema composition.

4. The method according to claim 1 wherein the identifying information resides in a caption.

5. The method according to claim 1 wherein the identifying information resides in a subtitle.

6. The method according to claim 1 wherein the identifying information resides in a resource presentation list.

7. The method according to claim 1 wherein the identifying information comprises resides in reel identification data.

8. The method according to claim 1 further including the steps of:
c) repeatedly performing steps a) and b) for a plurality of compositions; and,
d) generating a report indicative of what compositions played based on the data.

9. The method according to claim 3 further including the steps of:
d) repeatedly performing steps a), b), and c) for a plurality of compositions; and,
e) generating a report indicative of what compositions played and to what particular fraction, based on the data.

10. The method according to claim 1 further including the steps of:
c) detecting second identifying information corresponding to a second digital cinema composition, where the second digital cinema composition is a feature;
d) logging second data representative of the second digital cinema composition having played out based on the second identifying information, said second data further including a first start time of the second digital cinema composition; and,
wherein the first data further comprising a second start time of the first digital cinema composition;
whereby a determination can be made whether the first composition played out within a predetermined interval prior to the second composition by comparing the first and second start times.

11. The method according to claim 10 further including the steps of:
e) repeatedly performing steps a) and b) for each of a plurality of first compositions; and,
f) generating a report to indicate that the plurality of first compositions played based on the first data, the report further indicating those first compositions which played out within the predetermined interval prior to the second composition.

12. A system for tracking playout of a first digital cinema composition, comprising a playout monitor module for a) detecting first identifying information corresponding to first auxiliary content while the first digital cinema composition undergoes playout, the identifying information specific to one of the first digital cinema composition, a reel of the first digital cinema composition, an auxiliary content file comprising the first auxiliary content, and at least a portion of the first auxiliary content; and b) logging first data representative of the composition having played based on the identifying information.

13. The system according to claim 12 wherein the playout monitor module further (c) establishes from at least the first identifying information that a particular fraction of the composition has played; and, wherein the data is further representative of the particular fraction.

14. The system according to claim 12 wherein the playout monitor module further c) establishes from at least the first identifying information that a particular fraction of the composition has played; and, wherein the logging step occurs in response to the particular fraction being at least a predetermined fraction of the composition.

16. The system according to claim 12 wherein the identifying information resides in a caption.

17. The system according to claim 12 wherein the identifying information resides in a subtitle.

18. The system according to claim 12 wherein the identifying information resides in a resource presentation list.

19. The system according to claim 12 wherein the identifying information comprises resides in reel identification data.

20. The system according to claim 12 further comprising a database for storing the auxiliary content file and identifying information.

21. The system according to claim 12 wherein the playout monitor module generates a report indicative of what auxiliary content files played and for how long in accordance with the logged auxiliary content files and identifying information activity.

22. The system according to claim 12 wherein the playout monitor module further (c) detects second identifying information corresponding to a second digital cinema composition, where the second digital cinema composition is a feature; and (d) logs second data representative of the second digital cinema composition having played out based on the second identifying information, said second data further including a first start time of the second digital cinema composition; wherein the first data further comprising a second start time of the first digital cinema composition; and whereby a determination can be made whether the first composition played out within a predetermined interval prior to the second composition by comparing the first and second start times.
